(19) United States
(12) Patent Application Publication
(10) Pub. No.: US 2026/0346778 A1
(43) Pub. Date: Nov. 5, 2026

(54) ASSEMBLY, TRANSPORT DEVICE, INSTALLATION DEVICE, AND METHOD

(71) Applicant: VANILLA AUTOMATION CONSULTING GMBH, Premstaetten/Graz (AT)

(72) Inventor: Norbert Kahr, Premstaetten/Graz (AT)

(73) Assignee: VANILLA AUTOMATION CONSULTING GMBH, Premstaetten/Graz (AT)

(21) Appl. No.: 19/124,782

(22) PCT Filed: Oct. 18, 2023
(86) PCT No.: PCT/AT2023/060360

§ 371 Date: Apr. 25, 2025

(30) Foreign Application Priority Data
Oct. 31, 2022 (AT) A50835/2022
Oct. 31, 2022 (AT) GM50164/2022

(51) Int. Cl. B60P 1/36; B62B 5/04

(52) U.S. Cl. CPC B60P 1/36; B62B 5/0457

(57) ABSTRACT

The invention relates to an assembly, a mobile transport device, an installation device, and a method. The assembly includes a mobile transport device having a transport device conveyor device and an installation device having an installation device conveyor device. The transport device conveyor device and the installation device conveyor device are configured to receive and/or convey a workpiece. The installation device includes an electrical power source, in particular a current source and/or a battery. The mobile transport device does not include an electrical power source. The mobile transport device and the installation device are configured for reversible electrical connection to one another whereby the transport device conveyor device is supplied with electrical power from the electrical power source of the installation device.

### CROSS-REFERENCE TO RELATED APPLICATION(S)

This application is the National Stage of International Patent Application No. PCT/AT2023/060360, filed on Oct. 18, 2023, which claims priority from Austrian Patent Application No. A 50835/2022 filed on Oct. 31, 2022 and Austrian Patent Application No. GM50164/2022 filed on Oct. 31, 2022, both of which are herein incorporated by reference in their entireties.

### BACKGROUND

The invention relates to an assembly, a transport device, an installation device and a method according to the preamble of the independent claims.

Various installation lines are known from the prior art.

For example, it is known from the prior art that workpiece carriers are conveyed within an installation line between the installation devices with a transfer system or via automatic transport robots with permanently built-on roller conveyor technology or similar permanently built-on workpiece carrier receptacles. These installation lines have limitations with regard to flexibility, scalability, accessibility and efficiency.

For example, installation lines with work stations and workpiece carriers for workpieces are known from the prior art. Such installation lines consist of a workpiece carrier transfer system which transports the workpiece carriers. However, a disadvantage of these installation lines is that they are limited in flexibility by the rigid linkage of the individual modules with the workpiece carrier transfer system. Individual modules, stations and processes cannot be approached in individual order with the workpiece carrier. In the case of conversions and extensions of such installation lines, in some cases very high expenditures and longer production stoppages are necessary. In addition, the accessibility of the installation devices is restricted by the workpiece carrier transfer systems.

Furthermore, autonomous mobile robots are known from the prior art. Known autonomous mobile robots consist of a body and a transport device embodied as a workpiece or workpiece carrier receptacle. However, a disadvantage of these conventional robots is that the transport device is fixedly connected to the robot. The transport device cannot be employed without a robot and cannot be operated manually.

From the prior art, mobile robots are also known as conveyor systems, which comprise a conveyor belt which is configured such that it receives an object from the mobile robot and/or delivers the object to the mobile robot. Such conveyor systems are configured such that it conveys the object within the operating environment during the movement of the mobile robot. However, a disadvantage of these conventional conveyor systems is that the transport device is fixedly connected to the transport robot. The transport device cannot be employed without a robot and cannot be operated manually.

### SUMMARY

The object of the invention is to overcome the disadvantages of the prior art. In particular, it is an object of the invention to create an assembly, in particular an installation line, a transport device, an installation device and a method, wherein the transport devices can be employed flexibly and independently. It is therefore an object of the present invention, among other things, to create an assembly, a transport device, an installation device and a method which permits efficient and economical operation of the assembly both in case of low and high production unit numbers.

The object according to the invention is achieved in particular by the features of the independent claims.

In particular, the invention relates to an assembly, in particular an installation line or a part of an installation line, preferably for conveying and/or machining a workpiece and/or a workpiece carrier, wherein the assembly comprises at least one, in particular mobile, transport device, at least one, in particular stationary, installation device and optionally a transport robot.

In particular, it is provided that the transport device can be changed in its position relative to the installation device.

It is optionally provided that the transport device is designed such that the transport device can be driven and/or moved by the transport robot and/or an operator. In particular, the transport device can be driven and/or moved by the transport robot and/or an operator from one installation device to another installation device.

In particular, the transport device, in particular the transport device conveyor device, can be moved decoupled from a transport robot and/or a hand pallet truck optionally moving the transport device.

Preferably, it can be provided that the transport device comprises a transport device conveyor device, in particular a roller conveyor.

Preferably, it can be provided that the installation device comprises an installation device conveyor device, in particular a roller conveyor.

Preferably, it is provided that the transport device conveyor device and the installation device conveyor device are set up and/or formed for receiving and/or conveying a workpiece and/or a workpiece carrier.

In particular, the transport device conveyor device and/or the installation device conveyor device can be formed as a workpiece receiving device and/or as a workpiece carrier receiving device. In particular, the transport device conveyor device and/or the installation device conveyor device can comprise a workpiece receiving device and/or a workpiece carrier receiving device.

In particular, the transport device conveyor device and/or the installation device conveyor device can be formed and/or set up for conveying, transporting and/or moving a workpiece.

In particular, the transport device conveyor device can be arranged on the upper side of the transport device.

Preferably, the installation device comprises a handover station. In particular, the installation device conveyor device can be arranged on the upper side of the installation device, in particular the handover station.

In particular, the transport device conveyor device and the installation device conveyor device can be arranged at the same height relative to one another, so that optionally a conveying of the workpiece from the transport device to the installation device is possible.

Optionally, the transport device can receive workpieces via the transport device conveyor device, in particular the roller conveyor of the transport device. Optionally, the installation device can receive workpieces via the installation device conveyor device, in particular the roller conveyor of the installation device.

Within the framework of the present invention, the term workpiece can be understood to mean at least one workpiece and/or at least one workpiece carrier.

Optionally, it can be provided that the transport device is designed and/or formed for the connection, in particular reversible and/or positive, to the transport robot, so that the transport device can optionally be moved by the transport robot.

In particular, it is provided that the transport device is designed such that the transport device can be connected to the transport robot, in particular reversibly and/or positively, preferably for moving the transport device by the transport robot.

Optionally, it can be provided that the transport device is designed such that the transport device can be connected to the transport robot, in particular reversibly and/or positively, so that the transport device can be moved and/or driven by the transport robot.

Optionally, it can be provided that the transport robot is formed for reversible and/or positive connection to the transport device.

In particular, the transport robot is formed to move the transport device, in particular the transport device and a workpiece lying on the transport device.

In particular, it can be provided that the transport device comprises a pulling device which is formed for the reversible and/or positive connection to a coupling device of the transport robot.

Preferably, it can be provided that the installation device comprises an electric power source, in particular a current source and/or a battery.

Preferably, it can be provided that the transport device is designed and/or formed free of power sources, in particular current sources and/or batteries.

Preferably, it can be provided that the transport device and the installation device are set up for electrical connection to one another, so that electric power, in particular current, can optionally be transmitted from the installation device to the transport device when the transport device is electrically connected to the installation device.

Preferably, it can be provided that the transport device is designed and/or formed such that the transport device, in particular the transport device conveyor device, is preferably exclusively supplied and/or can be supplied with electric power, in particular current, from, in particular, the electric power source of the installation device, in particular when the transport device is electrically connected to the installation device.

Optionally, it can be provided that the transport device, in particular the transport device conveyor device, is preferably exclusively supplied and/or can be supplied with electric power, in particular current, from, in particular, the electric power source of the installation device.

Optionally, the transport device can be electrically connected to the installation devices, in particular the handover station, and/or supplied with electric power.

Optionally, it is provided that the installation device is designed and/or formed such that the installation device, in particular the handover station of the installation device, the transport device, in particular the transport device conveyor device, is supplied and/or can be supplied with electrical energy, in particular current, by the installation device.

In particular, the transport device and the installation device are formed and/or set up to be electrically connected to one another, so that electrical energy, in particular current, can optionally be transmitted.

In particular, it is provided that an activation of the transport device conveyor device, in particular a movement of the rollers of the roller conveyor of the transport device, is only possible if the transport device is electrically connected to the installation device.

The transport device can optionally be formed free of power sources, batteries, current sources and/or current storage. Within the framework of the invention, a transport device free of power sources, batteries, current sources and/or current storage devices can be understood as meaning a transport device which has no energy source, no battery, no current source, no current storage or the like.

Due to the fact that the transport device can be supplied with energy, in particular exclusively, via the installation device, the construction of the transport devices is simple compared to conventional embodiments known from the prior art and is therefore extremely economical, since the transport device has no energy source, no battery, no power source and/or no power storage. In other words, it is optionally provided that the current supply of the transport device, in particular of the transport device conveyor device, is preferably effected exclusively via the installation device.

In addition, the transport devices can also be located without a transport robot, in particular separated and/or decoupled from the transport robot, at, preferably the handover station, of the installation device for loading or unloading. As a result, the transport robot is optionally available for other tasks during this time, which is very economical, especially for smaller production quantities or during the ramp-up of a production line. Optionally, the transport robot can be connected to another transport device during the loading process or the unloading process and optionally move this other transport device.

Optionally, the assembly is formed as an installation line or a part of an installation line.

In particular, the invention relates to an installation assembly, in particular an installation line, wherein the installation assembly optionally comprises several assemblies according to the invention, in particular several transport devices according to the invention, several installation devices according to the invention and at least one transport robot.

Optionally, workpieces can be conveyed between the individual installation devices on mobile transport devices at the assembly and/or the installation assembly.

The transport device can comprise externally driven transport device conveyor devices, in particular roller conveyors.

The mobile transport devices can be moved between the individual installation devices by a transport robot or by an operator.

Optionally, the transport device, in particular the transport device conveyor device, can be supplied, activated and/or driven exclusively via an external electrical energy source, such as in particular the current source of the installation device.

In particular, the transport device, preferably the transport device conveyor device, can be supplied, activated and/or driven exclusively by the electrical energy source, preferably the current source, of the installation device, with energy, in particular during loading and unloading.

In other words, it can be provided that the transport device conveyor device is supplied and/or can be supplied with electrical energy exclusively from the electrical energy source of the installation device.

In particular, it is provided that the transport device is designed such that the transport device is without current when it is moved.

Optionally, it is provided that, in particular exclusively, an electrical connection between the transport device and the installation device is produced and/or can be produced. In particular, a mechanical connection of the transport device to the installation device known from the prior art is thus optionally unnecessary.

Optionally, the transport device conveyor device and/or the installation device conveyor device is set up for conveying workpiece carriers and/or workpieces with a weight in a range of 50 kg up to and including 300 kg, in particular with a weight of 150 kg. In particular, the transport device conveyor device and/or the installation device conveyor device is set up for conveying motors, electric motors, electric drives, drive axes, batteries, fuel cells, gears, converters and/or parts thereof.

Optionally, the transport device has a length of between 80 cm and including 120 cm, in particular of 100 cm.

Optionally, the transport device has a width of between 80 cm and including 120 cm, in particular of 100 cm.

Optionally, the transport device has a height of between 50 cm and including 120 cm, in particular of 100 cm.

Optionally, the transport robot is set up for moving a weight in a range of 50 kg up to and including 600 kg, in particular with a weight of 300 kg.

Within the framework of the present invention, a transport device can also be understood as a transport unit. Within the framework of the present invention, an installation device can also be understood as an installation unit.

Within the framework of the present invention, a transport robot can be understood as any robot which is set up and/or formed for moving the transport device and optionally a workpiece arranged thereon.

Within the framework of the present invention, an installation device can also be understood as an installation module or an installation station which is set up and/or formed for machining the workpiece or the workpiece carriers.

Within the framework of the present invention, a ground can be understood as the ground and/or the underground on which the transport device and/or installation devices stand.

Within the framework of the present invention, an electrical connection can be understood as an electrical coupling and/or an inductive electrical connection.

Optionally, it is provided that the transport device comprises at least one moving device, in particular rollers or wheels, or standing feet.

Optionally, it is provided that the transport device comprises a braking device, in particular a dead man's brake.

Optionally, it is provided that the braking device is formed to block the at least one moving device, in particular the rotation of the rollers or wheels, so that optionally the movability, the mobility and/or the drivability of the transport device is prevented.

The transport device can have at least one moving device, in particular rollers or wheels, by means of which the transport device can be driven and/or moved on the ground. Optionally, it is provided that the moving devices, in particular the rollers or wheels, roll on the floor during the movement of the transport device. By means of the moving devices, the transport device and a workpiece lying thereon can optionally be moved by an operator without a hand pallet truck.

The transport device can have at least one standing foot, in particular four standing feet, with which the transport device is supported and/or stands on the ground.

In particular, it can be provided that the transport devices, in particular the transport device which comprises at least one standing foot, are designed such that the transport device can be lifted for movement by a transport robot and/or a hand pallet truck.

In other words, it is optionally provided that the transport device, in particular its standing feet or its moving devices, is removed from the ground by the lifting by the transport robot and/or a hand pallet truck and is thus in particular without contact to the ground.

Optionally, it is provided that the transport device, which has standing feet, is lifted by a transport robot and can subsequently be moved and/or driven.

Optionally, it is provided that a transport device which has standing feet is lifted by an operator, in particular a conventional hand pallet truck, and can subsequently be moved and/or driven. As a result, it is optionally possible for the arrangement, in particular the installation line, to be economically operable in the run-up phase or in case of small quantities. Further, it is thereby optionally possible to continue and/or maintain the production by means of operators in the event of a possible malfunction and/or failure of the transport robots.

The inventor explains that, in addition, the requirements for scalability can also be met as additional transport devices and installation devices can be tested in advance by the manual movement, in particular the movement by an operator, of the transport devices. In particular, transport robots can be integrated into existing assemblies, in particular installation lines, following a test phase without a long production standstill.

In particular, it can be provided that the transport device, in particular the transport device which comprise moving devices, is designed such that the transport device, such as a trailer, can be pulled by the transport robot.

In particular, the transport robots can have and/or comprise a coupling device, in particular an extendable coupling device, in particular a hook device and/or a bolt, for mechanical coupling to the transport device.

The transport robots can be controlled and regulated by a control device.

Optionally, it is provided that the braking device can be brought from a moving position into a braking position, in particular by actuating an operating device, in particular by actuating an unlocking device of the operating device, preferably by means of a Bowden cable, of the transport device.

In particular, it is provided that the braking device can be moved from the braking position into the moving position, in particular by the actuation of the operating device.

The operating device can comprise an unlocking device, in particular for bringing the brake device into the moving position, preferably for unlocking the dead man's brake. The operating device can be formed as a handle.

Optionally, it is provided that the braking device in the moving position releases the moving device, in particular the rotation of the rollers or wheels, so that optionally the transport device is movable, mobile and/or drivable.

Optionally, it is provided that the braking device in the braking position blocks and/or fixes the moving device, in particular the rotation of the rollers or wheels, so that optionally the movability, mobility and/or drivability of the transport device is prevented.

In particular, it is provided that the braking device is designed such that the braking device can be brought from a moving position into a braking position and from a braking position into a moving position, in particular by the actuation of an operating device of the transport device. Optionally, it is provided that the braking device can have two positions, in particular the moving position and the braking position.

In particular, it is provided that the braking device is designed such that the braking device releases the moving device, in particular the rotation of the rollers or wheels, in the moving position. Optionally, it is provided that the transport device is movable, mobile and/or drivable when the braking device is in the moving position.

In particular, it is provided that the braking device is designed such that the braking device blocks and/or fixes the moving device, in particular the rotation of the rollers or wheels, in the braking position. Optionally, it is provided that the movability, mobility and/or drivability of the transport device is prevented when the brake device is in the braking position.

Optionally, it is provided that the transport device, in particular the braking device, comprises a blocking device.

Optionally, it is provided that the locking device can be brought from a release position into a locking position.

In particular, the locking device is designed such that the locking device can be brought from a release position into a locking position and/or from a locking position into the release position. Optionally, it is provided that the locking device can have two positions, in particular the release position and the locking position.

Optionally, it is provided that the locking device is designed such that the braking device is held and/or secured in the braking position, in particular the unlocking of the dead man's brake is locked and/or prevented when the locking device is in the locking position.

In particular, it is provided that the locking device holds and/or secures the braking device in the braking position in the locking position, in particular locks and/or prevents the unlocking of the dead man's brake.

Optionally, it is provided that, by actuating the operating device, in particular the unlocking device, the braking device cannot be brought into the moving position when the locking device is in the locking position.

Optionally, in practice, the operator actuates the operating device, in particular the unlocking device, as a result of which the braking device is brought into the moving position, in particular the dead man's brake is releasable and/or ventable, so that the transport device is movable and/or displaceable. The actuation of the operating device, in particular of the unlocking device, can optionally be transmitted to the braking device via a Bowden cable, so that the braking device is moved from the braking position into the moving position.

Optionally, it is provided that the locking device is brought into the locking position as soon as the transport device is electrically connected to the installation device, as a result of which a movement and/or displacement of the transport device, in particular to the installation device, is prevented. In particular, it is provided that the unlocking of the braking device, in particular the venting of the dead man's brake, preferably automatically, is locked during the electrical connection. The braking device can thus optionally not be moved from the braking position into the moving position, while the transport device is electrically connected to the installation device.

Optionally, it is provided that the locking device is in the locking position when the transport device is electrically connected and/or electrically coupled to the installation device.

Optionally, it is provided that the transport device has, in particular on its underside, an adapter device, preferably an adapter plate.

Optionally, it is provided that the adapter device is designed such that the transport device can be lifted by the transport robot and/or a hand pallet truck.

As a result, the transport device can be reversibly and/or positively connected and/or is connectable to the lifting device, in particular the transport robot and/or the hand pallet truck.

Optionally, it is provided that the transport device comprises a pulling device.

Optionally, it is provided that the pulling device is designed such that the pulling device can be reversibly and/or positively coupled and/or connected to one or the transport robot, in particular a coupling device of the transport robot.

Optionally, it is provided that the pulling device is designed such that the locking device can be moved or is brought from the locking position into the release position when the pulling device is actuated, in particular when the pulling device is coupled and/or connected to a transport robot, in particular the coupling device of the transport robot, preferably reversibly and/or positively.

In particular, the pulling device is formed as a towing device.

In particular, by actuating the pulling device, the locking device can be moved from the locking position into the release position and the braking device can be moved from the braking position into the moving position, so that optionally the transport device can be moved by the transport robot.

Optionally, it can be provided that the pulling device can be brought from a first position into a second position by actuation, in particular by, preferably mechanical, positive-locking and/or reversible, connection to a transport robot. The pulling device can be formed such that the pulling device brings the locking device from the locking position into the release position and the braking device from the braking position into the moving position when the pulling device is brought into the second position by the connection to the coupling device, so that optionally the transport device can be moved by the transport robot.

Optionally, it is provided that the transport device comprises two, in particular two-pole, contact receiving devices.

Optionally, it is provided that the contact receiving devices are arranged opposite one another on the transport device, in particular on two opposite side surfaces of the transport device.

Optionally, it is provided that the installation device, in particular a handover station of the installation device, comprises a contact producing device, in particular a two-pole contact producing device.

Optionally, it is provided that the contact receiving devices and/or the contact producing device are formed for the electrical connection and/or electrical coupling of the transport device to the installation device.

Optionally, it is provided that the contact receiving devices and/or the contact producing device is or are formed to produce an electrical connection and/or electrical coupling, preferably an electrical connection with 24 volt direct current, of the transport device to the installation device.

In particular, electrical energy, in particular from the installation device to the transport device, can be transmitted by the electrical connection and/or electrical coupling.

Optionally, it is provided that the transport device conveyor device has a first conveying direction when the contact producing device is connected to the contact receiving device and the contact producing device has a first polarity, so that optionally a workpiece arranged on the conveyor surface of the transport device can be moved in the first conveying direction.

Optionally, it is provided that the installation device, in particular the contact producing device, comprises or has two contact elements, wherein the contact elements are set up for establishing an electrical connection to the transport device, in particular the contact receiving devices. In particular, the contact elements can be pollable and/or polled depending on the desired conveying direction. Optionally, the positive and negative poles of the contact producing device, in particular of the contact elements, can be switched depending on the desired transport direction when the voltage is applied.

In particular, it is provided that the transport device conveyor device, in particular the rollers of the roller conveyor, is or are moved in a first direction when the contact producing device is connected to the contact receiving device and the contact producing device, in particular the contact elements, has or have a first polarity.

In particular, it is provided that the transport device conveyor device moves a workpiece in a first conveying direction when the contact producing device is connected to the contact receiving device and the contact producing device, in particular the contact elements, has or have a first polarity.

Optionally, it is provided that the transport device conveyor device has a second conveying direction, in particular a conveying direction opposite to the first conveying direction, if the contact producing device is connected to the same contact receiving device and the contact producing device has a second pole, in particular opposite to the first pole, so that optionally a workpiece arranged on the conveyor surface of the transport device can be moved in the second conveying direction.

In particular, it is provided that the transport device conveyor device, in particular the rollers of the roller conveyor, is or are moved in the second direction if the contact producing device, in particular the contact elements, has or have a second polarity.

In particular, it is provided that the transport device conveyor device moves a workpiece in the second conveying direction when the contact producing device is connected to the same contact receiving device and the contact producing device, in particular the contact elements, has or have a second polarity.

In particular, a workpiece can be moved in the first conveying direction with the transport device conveyor device if the contact elements have a first polarity. In particular, a workpiece can be moved with the transport device conveyor device in the second, in particular the first opposite, conveying direction when the contact elements have a second, in particular a polarity opposite to the first polarity.

Within the framework of the present invention, polarity can be understood as meaning the assignment and/or arrangement of the two poles, in particular the positive pole and the negative pole.

In particular, in the first position and/or the first pole, the positive pole can be assigned to the first contact element of the two contact elements and the negative pole can be assigned to the second contact element of the two contact elements. In particular, in the second position and/or the second pole, the first contact element of the two contact elements can be assigned the negative pole and the second contact element of the two contact elements can be assigned the positive pole.

Optionally, it is provided that the transport device conveyor device comprises a conveyor surface.

Optionally, it is provided that a conveyor surface is formed by the transport device conveyor device. Optionally, it is provided that a conveyor surface is formed by the installation device conveyor device. Optionally, it is provided that the transport device conveyor device and/or the installation device conveyor device has or have a conveyor surface.

Optionally, it is provided that the transport device conveyor device has, in particular, two limiting devices arranged parallel to one another.

In particular, the conveyor surface of the transport device, which preferably receives the workpiece, can be limited by the limiting devices on two, in particular parallel and/or opposite, sides of the conveyor surface, wherein the sides are optionally parallel to the, in particular first and/or second, conveying direction.

Optionally, it is provided that the transport device conveyor device comprises, in particular, two stop devices arranged parallel to one another.

In particular, the conveyor surface of the transport device, which preferably receives the workpiece, can be limited by the stop devices on two, in particular parallel and/or opposite, sides of the conveyor surface, wherein the sides are in particular transverse and/or normal to the, in particular first and/or second, conveying direction.

In particular, the conveyor surface can have four sides. Two of the four sides can be limited by the limiting devices and the other two sides can be limited by the stop devices.

The limiting device and/or the stop device can be formed such that they hold and/or secure a workpiece arranged on the conveyor surface of the transport device.

Optionally, it is provided that the stop device or the stop devices can be brought from a securing position into a release position.

In particular, it is provided that the stop device is designed such that the stop device can be brought from a securing position into a release position. Optionally, it is provided that the stop device or the stop devices can have two positions, in particular the securing position and the release position.

Optionally, it is provided that the stop device in the securing position limits the conveyor surface of the transport device, so that optionally a workpiece arranged on the conveyor surface of the transport device is held or secured.

Optionally, it is provided that the stop device in the release position releases the conveyor surface of the transport device on one side of the conveyor surface, so that optionally a workpiece arranged on the conveyor surface can be conveyed by the transport device, in particular into a region outside the conveyor surface of the transport device, by actuating the transport device conveyor device.

It can optionally be provided that the limiting devices and/or the stop devices in the securing position are designed such that a workpiece arranged on the conveyor surface of the transport device remains within the conveyor surface even when the transport device conveyor device is actuated and optionally cannot be conveyed into a region outside the conveyor surface of the transport device.

Optionally, it is provided that the stop device, in particular facing the installation device, is in the release position when the transport device is electrically coupled to the installation device.

It can be provided that a securing device is brought into the release position by the electrical connection of the transport device to the installation device.

In particular, it is provided that, when the transport device is electrically connected to the installation device, the securing device is brought into the release position, which adjoins the installation device, in particular the handover station of the installation device, and/or is closer to the latter.

Optionally, it is provided that the transport device comprises at least one sensor device.

Optionally, it is provided that the sensor device is formed to determine the position of the transport device, in particular the position of the transport device relative to the installation device.

Optionally, it is provided that the transport device comprises an emergency stop device.

Optionally, it is provided that the emergency stop device is formed to interrupt the electrical connection and/or electrical coupling between the transport device and the installation device.

In particular, it can be provided that, when the emergency stop device is actuated, an electrical connection and/or electrical coupling of the transport device to the installation device is interrupted, as a result of which optionally a movement of the transport device conveyor device, in particular of the rollers of the roller conveyor, can be stopped.

Optionally, it is provided that the transport device comprises a lighting device, in particular an operating light, which lights up when the transport device is electrically connected and/or electrically coupled to the installation device.

In particular, it can be provided that the lighting device lights up while the transport device is electrically connected to the installation device. This optionally makes it possible to inform an operator that the movement of the transport device is blocked by the braking device and optionally the blocking device.

Optionally, it can be provided that the transport device, the transport device conveyor device, the blocking device, the stop device, the emergency release device and/or the lighting device must be supplied with electrical energy for their function and thus optionally are only functional when the transport device is electrically connected to the installation device.

Optionally, it can be provided that the braking device, in particular the dead man's brake, can be actuated without current and in particular can be brought from the moving position into the braking position and from the braking position into the moving position without current.

In particular, the invention relates to a transport device according to the invention.

Preferably, it can be provided that the transport device comprises a transport device conveyor device, in particular a roller conveyor.

Preferably, it can be provided that the transport device conveyor device is set up for conveying at least one workpiece and/or at least one workpiece carrier.

Preferably, it can be provided that the transport device is formed to be free of a power source, a current source and/or a battery.

In particular, the transport device, in particular the transport device conveyor device can optionally be supplied with electrical energy only by an external electrical energy source, current source and/or battery, in particular the electrical energy source of the installation device according to the invention.

Preferably, it can be provided that the transport device comprises two, in particular opposite, preferably two-pole, contact receiving devices.

Preferably, it can be provided that the contact receiving devices are formed to provide an electrical connection and/or electrical coupling to the installation device according to the invention, in particular of the contact producing device, in particular of the assembly according to the invention, whereby the transport device, in particular the transport device conveyor device, is supplied and/or can be supplied with electrical energy, in particular current.

In particular, an activation, in particular a movement, of the transport device conveyor device can thus only be possible if the transport device is electrically connected to the installation device.

In particular, the invention relates to an installation device according to the invention.

Preferably, it can be provided that the installation device comprises an installation device conveyor device, in particular a roller conveyor.

Preferably, it can be provided that the installation device conveyor device is set up for conveying at least one workpiece and/or at least one workpiece carrier.

Preferably, it can be provided that the installation device comprises an in particular two-pole contact producing device.

Preferably, it can be provided that the contact producing device is formed to establish an electrical connection and/or electrical coupling to, in particular, the contact receiving devices, of the transport device according to the invention of the assembly according to the invention.

Optionally, the invention can relate to a transport robot, wherein the transport robot is designed such that the transport robot can be reversibly and/or positively connected to the transport device according to the invention.

Preferably, it can be provided that the transport robot comprises a lifting device for lifting the transport device and/or a coupling device for connection to the pulling device of the transport device for the reversible and/or positive connection.

Preferably, it can be provided that the transport robot is formed for moving the transport device.

The installation device according to the invention, the transport device according to the invention and/or the assembly according to the invention and their features can be taken from the description and/or the claims. The installation device, the transport device and/or the transport robot can have the features individually or in combination.

In particular, the invention relates to a method for loading and/or unloading a workpiece onto a transport device according to the invention of the assembly according to the invention.

Preferably, it can be provided that the method comprises the following steps:

Moving the transport device according to the invention to an installation device according to the invention of the assembly according to the invention, in particular by means of a transport robot or by an operator, preferably by means of a hand pallet truck.

Optionally determining the position of the transport device, in particular the position of the transport device to the installation device, with the sensor device.

Optionally checking whether the position of the transport device is in a predetermined handover position region.

Establishing the electrical connection and/or electrical coupling between the transport device and the installation device when the transport device is in the defined handover position region.

Activating, in particular moving, the transport device conveyor device of the transport device, so that optionally a workpiece is conveyed from the transport device to the installation device or optionally a workpiece is conveyed from the installation device to the transport device.

Optionally, it is provided that the method steps of the method follow one another as described above.

Optionally, it is provided that the method is controlled and/or regulated in an automated manner, in particular by a control unit of the assembly according to the invention.

Optionally, it is provided that the transport device is repositioned when the position of the transport device is outside the predetermined handover position region.

The handover position region can be a region which differs by a maximum of 3 cm from a predetermined handover position, in particular the position of the contact producing device.

Optionally, it can be provided that in the method according to the invention the stop device of the transport device, which is closer to the installation device or adjoins the installation device, is brought, in particular automatically, from the securing position into the release position when the transport device is electrically connected and/or electrically coupled to the installation device.

Optionally, it can be provided that in the method according to the invention the braking device is brought, in particular automatically, from the moving position into the braking position when the transport device is electrically connected and/or electrically coupled to the installation device.

Optionally, it can be provided that in the method according to the invention, the locking device is brought, in particular automatically, from the release position into the locking position when the transport device is electrically coupled to the installation device.

Optionally, the invention can relate to an installation assembly, in particular an installation line, which is constructed from several installation devices, with mobile transport devices transporting workpiece carriers, wherein the mobile transport devices are equipped with an externally driven roller conveyor.

Optionally, it can be provided that in the installation assembly the mobile transport devices with externally driven roller conveyor can be conveyed and/or are conveyed by a transport robot between the installation devices of the installation assembly.

Optionally, it can be provided that, in the installation assembly, the mobile transport devices with externally driven roller conveyor are not fixedly, in particular separably, connected to a transport robot, in particular the one conveying the transport device.

Optionally, it can be provided that in the installation assembly the mobile transport devices with externally driven roller conveyor can be conveyed manually by an operator between the installation devices of the installation line.

Optionally, it can be provided that, in the installation assembly, the mobile transport devices used for handover of the workpiece carriers do not mechanically, in particular exclusively electronically, dock at the handover stations of the installation device of the installation assembly.

Optionally, it can be provided that in the installation assembly the mobile transport devices are supplied externally with energy for the loading and unloading of the workpiece carrier via electrical contacting units, in particular the contact receiving device and/or the contact producing device, in the handover stations of the individual installation devices.

Further features according to the invention optionally result from the claims, the description of the exemplary embodiments and the figures.

### BRIEF DESCRIPTION OF THE DRAWINGS

The invention will now be explained further by way of example of exemplary, non-exclusive and/or non-limiting exemplary embodiments.

It should be noted that, in the different figures and/or embodiments, identical parts are optionally provided with identical reference numerals and/or identical component designations. The disclosures contained in the entire description can be applied mutatis mutandis to identical parts with identical reference numerals and/or identical component designations. The position data selected in the description, such as, for example, above, below, from the right, from the left, laterally and the like, can also be referred to the directly described and represented figure.

FIG. 1 shows a schematic layout or a schematic outline of a first embodiment of an assembly according to the invention, in particular of an installation line according to the invention,

FIG. 2 shows a schematic graphical representation of a front view of a first embodiment of a transport device according to the invention with rollers,

FIGS. 3a and 3b show a schematic graphical representation of the first embodiment of the transport device according to the invention with rollers in a side and ground plan,

FIG. 4 shows a schematic graphical representation of a front view of a second embodiment of the transport device according to the invention with standing feet,

FIGS. 5a and 5b show schematic graphical representations of the second embodiment of the transport device according to the invention with standing feet in a side and ground plan, and

FIGS. 6a and 6b show schematic graphical representations of the second embodiment of the transport device according to the invention with standing feet in side and ground plans.

### DETAILED DESCRIPTION OF THE PREFERRED EMBODIMENTS

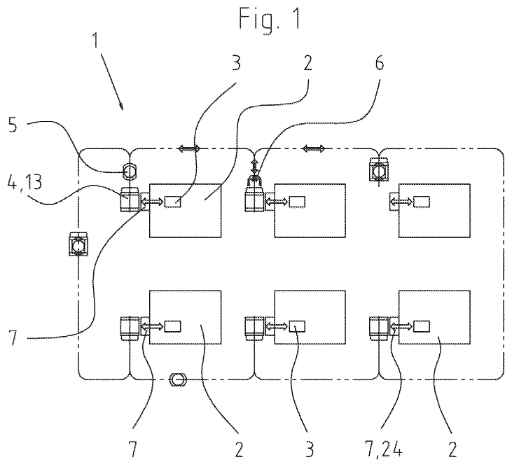

FIG. 1 represents a layout or plan view of an assembly 1 according to the invention which is constructed from several installation devices 2 and is connected by mobile transport devices 4 transporting workpiece 3, in particular workpiece carriers.

According to the first embodiment, the assembly 1 comprises mobile transport devices 4, installation devices 2 and transport robots 5.

The transport devices 4 are designed such that the transport device 4 can be connected to the transport robot 5 for movement of the transport device 4 by the transport robot 5.

The transport device 4 comprises a transport device conveyor device 13, in particular a roller conveyor. The installation device 2 comprises an installation device conveyor device 24, in particular a roller conveyor. The transport device conveyor device 13 and the installation device conveyor device 24 are designed to receive and/or convey a workpiece 3.

The installation device 2 comprises an electrical energy source, in particular a current source and/or a battery. The transport device 4 is formed free of power sources, in particular current sources and/or batteries. The transport device 4, in particular the transport device conveyor device 13, is supplied and/or can be supplied with current exclusively by, in particular the electrical energy source, of the installation device 2.

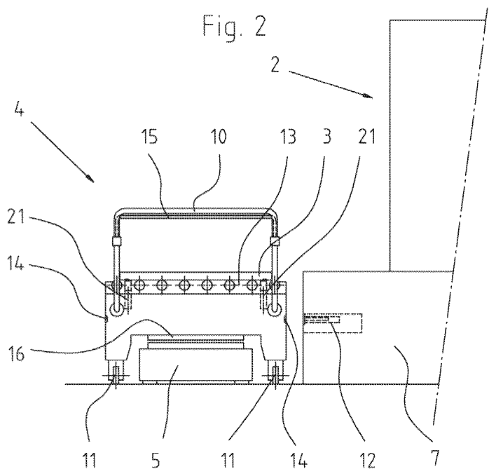

The inventor notes that the transport devices 4 according to this embodiment can be designed as a transport trolley with moving devices 11 or as a transport frame with standing feet 17 and can be transported either by an in particular automatic transport robot 5 or manually by an operator 6 from one installation device 2 to the next installation device 2. Further features of the transport devices 4 and of the installation devices 2 can be seen, inter alia, in FIGS. 2, 3a, 3b, 4, 5a, 5b and/or 6.

The transport devices 4 are not fixedly connected to the transport robot 5.

Transport device conveyor devices 13, in particular externally driven roller conveyors, for receiving workpieces 3 are integrated on the transport devices 4. The transport device conveyor devices 13 can be supplied with energy exclusively by an external energy supply in the handover station 7 during loading and unloading.

The workpieces 3 can be loaded into the transport device 4, inter alia, in the handover position 7 into an installation device 2 and can be unloaded at the handover position 7 of another installation device 2.

The inventor states that it is a great advantage of the assembly 1 that the transport robot 5 does not have to wait in the handover position 7 during the loading and unloading process and can process other transport or conveying orders during this time, since the transport robot 5 is not fixedly connected to the transport device 4. This results in considerable economic advantages during the production ramp-up of assemblies 1 according to the invention and in projects with low production quantities.

A further advantage is that it is possible to continue and/or maintain production by means of operators in the event of a possible malfunction and/or failure of the transport robots. A further advantage of the assembly 1 is that the independent automatic transport robots 5, which are not rigidly connected to the transport devices 4, can be used for other projects and tasks.

The method for loading and/or unloading a workpiece 3 can be carried out with the assembly 1 according to the figure.

The transport device 4 is moved to an installation device 2, in particular by means of the transport robot 5 or by an operator 6, preferably by means of a hand pallet truck 8. Subsequently, the position of the transport device 4, in particular the position of the transport device 4 relative to the installation device 2, is determined with the sensor device. In a further step, it is checked whether the position of the transport device 4 is in a predetermined handover position region. Subsequently, the electrical connection, in particular to the contact producing device 12 and contact receiving devices 14, between the transport device 4 and the installation device 2, is established when the transport device 4 in the defined handover position region. Thus, the transport device conveyor device 13 is supplied with electrical energy and can be activated so that a workpiece 3 is conveyed from the transport device 4 to the installation device 2 or from the installation device 2 to the transport device 4.

FIG. 2 shows a schematic graphical representation of a front view of a first embodiment of a transport device 4 according to the invention with rollers and an installation device 2.

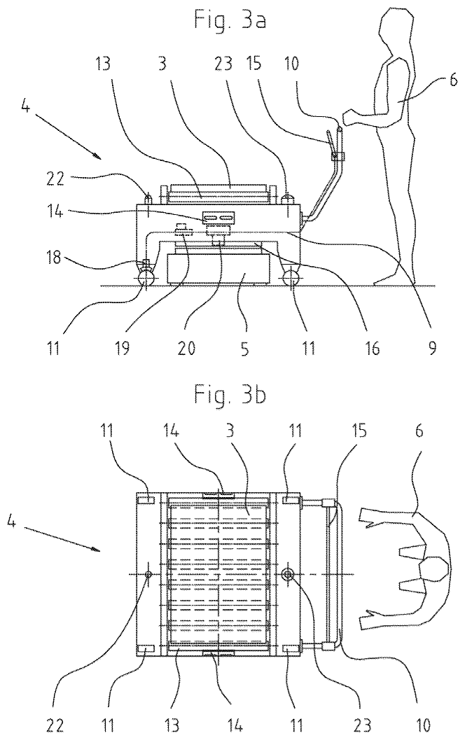

FIGS. 3a and 3b show a schematic graphical representation of the first embodiment of the transport device 4 according to the invention with rollers in a side and ground plan.

The features of the embodiment according to FIG. 2, 3a or 3b can preferably correspond to the features of the embodiment according to FIG. 1.

According to this embodiment, the transport device 4 comprises moving devices 11, in particular wheels.

Further, the transport device 4 comprises a braking device 18, in particular a dead man's brake, wherein the braking device 18 is formed to block the moving devices 11, in particular the rotation of the wheels, so that the movability of the transport device 4 is prevented.

The braking device 18 can be moved from a moving position into a braking position by the actuation of an unlocking device 15 of the operating device 10 by a Bowden cable 9 of the transport device 4.

In the moving position, the braking device 18 releases the moving device 11, in particular the rotation of the wheels, so that the transport device 4 is movable.

In the braking position, the braking device 18 blocks the moving device 11, in particular the rotation of the rollers or wheels, so that the movability of the transport device 4 is prevented.

The transport device 4 comprises a locking device 19 which can be brought from a release position into a locking position.

The locking device 19 is designed such that the braking device 18 is held and/or secured in the braking position, in particular the unlocking of the dead man's brake is locked by the unlocking device 15 when the locking device 19 is in the locking position.

The locking device 19 is in the locking position when the transport device 4 is electrically connected to the installation device 2.

The transport device 4 comprises two, in particular two-pole, contact receiving devices 14. The contact receiving devices 14 are arranged opposite one another on the transport device 4.

The installation device 2, in particular a handover station 7 of the installation device 2, comprises a contact producing device 12, in particular a two-pole contact producing device.

The contact receiving devices 14 and the contact producing device 12 are formed for the electrical connection of the transport device 4 to the installation device 2.

The contact producing device comprises two contact elements, wherein the contact elements are designed to produce an electrical connection to the transport device. The contact elements can be poled according to the desired conveying direction.

The transport device conveyor device 13 has a first conveying direction when the contact producing device 12 is connected to the contact receiving device 14 and has a first polarity, so that a workpiece 3 is moved in the first conveying direction.

The transport device conveyor device 13 has a second conveying direction, namely opposite to the first conveying direction, when the contact producing device 12 is connected to the same contact receiving device 14 and has a second, namely a polarity opposite to the first polarity, so that a workpiece 3 is moved in the second conveying direction.

The transport device conveyor device 13 comprises a conveyor surface.

The transport device conveyor device 13 has two limiting devices arranged parallel to one another, as a result of which the conveyor surface of the transport device 4 is limited on two opposite sides, which are in particular parallel to the conveying direction.

Further, the transport device conveyor device 13 comprises two stop devices 21 arranged parallel to one another, as a result of which the conveyor surface of the transport device 4 is limited on two opposite sides, which are in particular transverse to the conveying direction.

The transport device 4 comprises an emergency stop device 23 which is formed to interrupt the electrical connection between the transport device 4 and the installation device 2.

Further, the transport device 4 comprises a lighting device 22, in particular an operating light, which lights up when the transport device 4 is electrically connected to the installation device 2.

The schematically represented first embodiment of the transport device 4 according to the invention can transport a workpiece 3 between the individual installation devices 2 of the assembly 1 according to FIG. 1.

The represented transport device 4 is embodied as a transport carriage with moving devices 11, which are formed as rollers. The transport device 4 can be moved with transport robots 5 or manually by an operator 6.

The operator 6 uses the operating device 10, which is formed as a handle, for conveying the transport carriage.

On the base frame of the mobile transport device 4, on the left and right workpiece carrier handover sides, there are the contact receiving devices 14, which are contacted via the contact producing device 12 of the installation device 2 in the handover station 7 of the installation device 2.

For loading or unloading the workpiece 3, the transport device 4 is electrically contacted and connected in the handover station 7 by a contact producing device 12.

The inventor notes that it is a great advantage of this embodiment that a mechanical docking of the transport device 4 in the handover station 7 is not necessary.

The position tolerances which occur during the automatic or manual positioning of the transport device 4 can be compensated by the transport device conveyor device 13, in particular the externally driven roller conveyor, and the handover station 7.

The transport device 4 according to this embodiment has a braking device 18 which is released by actuating an unlocking device 15 on the operating device 10 during manual transport. According to this embodiment, the brake device 18 is formed as a dead man's brake.

When the transport device 4 is automatically transported by a transport robot 5 without a lifting unit, the braking device 18 is released by the coupling device 20 of the transport robot 5.

When the transport device 4 is transported manually by an operator 6, the brake device 18 is unlocked according to this embodiment by means of a Bowden cable 9 or an unlocking device 15.

In order to prevent the braking device 18 from being released by an operator 6 or a transport robot 5 during the loading and unloading of the workpiece 3 in the handover station 7, the locking device 19 of the transport device 4 is brought into the locking position during the contacting of the transport device 4.

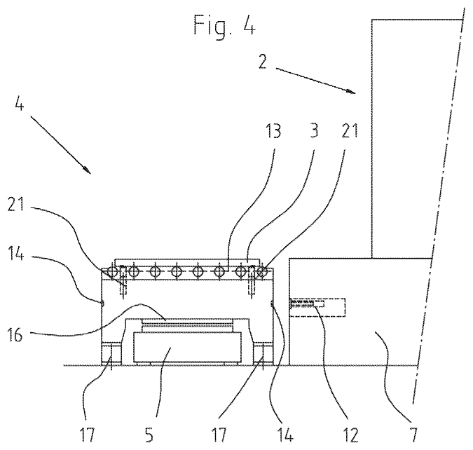

FIG. 4 shows a schematic graphic representation of a front view of a second embodiment of a transport device 4 according to the invention with standing feet 17 and an installation device 2.

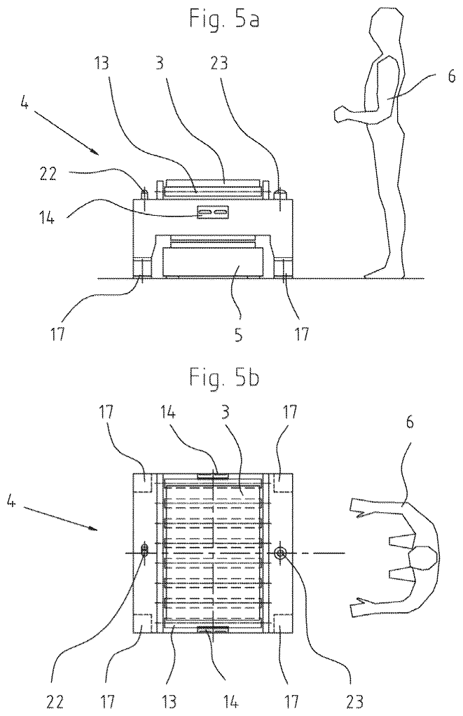

FIGS. 5a and 5b show a schematic graphical representation of the second embodiment of the transport device 4 according to the invention with standing feet 17 in a side and ground plan.

The features of the embodiment according to FIG. 4, 5a or 5b can preferably correspond to the features of the embodiments according to FIG. 1, 2, 3a or 3b.

The schematically represented second embodiment of the transport device 4 according to the invention can transport a workpiece 3 between the individual installation devices 2 of the assembly 1.

The represented transport device 4 is embodied as a transport frame with standing feet 17. The transport device 4 can be conveyed with transport robots 5 or manually by an operator 6 by means of conventional hand pallet trucks 8. For loading or unloading the workpiece 3, in particular the workpiece carrier, the transport device 4, in particular the contact receiving devices 14 of the transport device 4, is electrically contacted in the handover station 7 by a contact producing device 12.

The inventor states that it is a great advantage of this embodiment that a mechanical docking of the transport device 4 in the handover station 7 is not necessary.

The position tolerances which occur during the automatic or manual positioning of the transport device 4 can be compensated by the transport device conveyor device 13, in particular the externally driven roller conveyor, and the handover station 7.

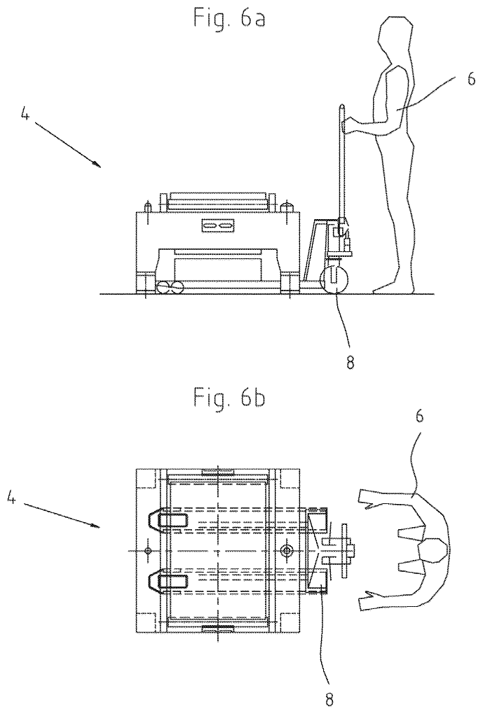

FIGS. 6a and 6b show schematic representations of the second embodiment of the transport device 4 according to the invention with standing feet 17 and a hand pallet truck 8 in side and ground plans.

The features of the embodiment according to FIGS. 6a and 6b can preferably correspond to the features of the embodiments according to FIG. 1, 2, 3a, 3b, 4, 5a or 5b.

The schematically represented third embodiment of the transport device 4 according to the invention is embodied as a transport frame with standing feet 17.

FIG. 6 shows, in addition to the previous representations, an operator 6 which can convey the transport device 4 by means of conventional hand pallet trucks 8.

The invention is not limited to the represented embodiments, but comprises any assembly 1, any transport device 4, any installation device 2 and any method according to the following claims.

### LIST OF REFERENCE NUMERALS

1—Assembly
2—Installation Device
3—Workpiece
4—Transport Device
5—Transport Robot
6—Operator
7—Handover Station
8—Hand Pallet Truck
9—Bowden Cable
10—Operating Device
11—Moving Device
12—Contact Producing Device
13—Transport Device Conveyor Device
14—Contact Receiving Device
15—Unlocking Device
16—Adapter Device
17—Standing Feet
18—Braking Device
19—Locking Device
20—Coupling Device
21—Stop Device
22—Lighting Device
23—Emergency Stop Device
24—Installation Device Conveyor Device

1-15. (canceled)

16. An assembly comprising:
at least one mobile transport device that includes a transport device conveyor device; and
at least one installation device that includes an installation device conveyor device;
wherein the transport device conveyor device and the installation device conveyor device are configured to receive and convey at least one workpiece;
wherein the at least one installation device further includes an electrical power source comprising at least one of a current source and a battery;
wherein the at least one mobile transport device does not include an electrical power source comprising at least one of a current source and a battery;
wherein the at least one mobile transport device and the at least one installation device are configured for reversible electrical connection to one another; and
wherein the at least one mobile transport device is configured such that the transport device conveyor device is supplied with electrical power from the electrical power source of the at least one installation device.

17. An assembly according to claim 16, wherein:
the transport device conveyor device comprises a roller conveyor; and/or
installation device conveyor device comprises a roller conveyor.

18. An assembly according to claim 16, wherein:
the at least one mobile transport device is configured such that the transport device conveyor device is supplied with electrical power exclusively from the electrical power source of the at least one installation device.

19. An assembly according to claim 16, wherein:
the at least one mobile transport device further includes at least one of rollers, wheels, and standing feet.

20. An assembly according to claim 16, further comprising:
a brake device configured to limit movability of the at least one mobile transport device.

21. An assembly according to claim 19, wherein:
the brake device is configured to be actuated from a moving position to a braking position;
wherein, in the moving position, movement of the at least one mobile transport device is permitted, and
wherein, in the braking position, movement of the at least one mobile transport device is prevented.

22. An assembly according to claim 21, wherein:
the brake device is configured to be actuated from the moving position to the braking position by operation of an unlocking device of the at least one mobile transport device.

23. An assembly according to claim 22, wherein:
the unlocking device comprises a Bowden cable.

24. An assembly according to claim 20, further comprising:
a locking device having a release position and a locking position;
wherein the locking device is configured to hold or secure the brake device in its braking position when the locking device is in its locking position.

25. An assembly according to claim 24, wherein:
the locking device is configured in its locking position when the at least one mobile transport device is electrically connected to the at least one installation device.

26. An assembly according to claim 24, wherein:
the at least one mobile transport device includes a pulling device, wherein the pulling device is configured to be operably coupled to a transport robot, and wherein the pulling device is configured such that actuation of the pulling device actuates the locking device to move from its locking position to its release position when the pulling device is operably coupled to the transport robot.

27. An assembly according to claim 16, wherein:
the at least one mobile transport device has an underside with an adapter device, wherein the adapter device is configured such that the at least one mobile transport device can be lifted by a transport robot or hand pallet truck; and/or
the assembly further includes at least one transport robot; and/or
the at least one mobile transport device is configured to be operably coupled to a transport robot such that the at least one mobile transport device can be moved by the transport robot.

28. An assembly according to claim 16, wherein:
the at least one mobile transport device comprises a two-pole contact receiving device; and
the at least one installation device comprises a two-pole contact producing device, wherein the two-pole contact receiving device and the two-pole contact producing device are configured to electrically connect the at least one mobile transport device to the at least one installation device.

29. An assembly according to claim 28, wherein:
the at least one mobile transport device comprises two two-pole contact receiving devices arranged opposite one another on the at least one mobile transport device.

30. An assembly according to claim 28, wherein:
the transport device conveyor device is configured to operate in a first conveying direction when the two-pole contact producing device is connected to the two-pole contact receiving device and has a first polarity to permit the at least one workpiece to be conveyed in the first conveying direction; and
the transport device conveyor device is configured to operate in a second conveying direction opposite the first conveying direction when the two-pole contact producing device is connected to the two-pole contact receiving device and has a second polarity to permit the at least one workpiece to be conveyed in the second conveying direction.

31. An assembly according to claim 16, wherein:
the transport device conveyor device has a conveyor surface with two limiting devices which are arranged parallel to one another on opposite sides of the conveyor surface.

32. An assembly according to claim 31, wherein:
the transport device conveyor device further includes at least one stop device for limiting conveyance of the least one workpiece on the conveyor surface of the transport device conveyor device.

33. An assembly according to claim 32, wherein:
the at least one stop device is operable in a securing position and a release position;
wherein, in the securing position, the at least one stop device limits operation of the conveyor surface such that a workpiece arranged on the conveyor surface is held or secured; and
wherein, in the release position, the at least one stop device releases the conveyor surface such that a workpiece arranged on the conveyor surface can be conveyed by actuating the transport device conveyor device.

34. An assembly according to claim 33, wherein:
the at least one stop device is configured in its release position when the at least one mobile transport device is electrically connected to the at least one installation device.

35. An assembly according to claim 16, wherein
the at least one mobile transport device includes at least one sensor device configured to sense position of the at least one mobile transport device relative to the at least one installation device; and/or
the at least one mobile transport device includes an emergency release device configured to interrupt the electrical connection between the least one mobile transport device and the at least one installation device; and/or
the at least one mobile transport device includes an operating light configured to emit light when the at least one mobile transport device is electrically connected to the least one installation device.

36. A method for loading and/or unloading a workpiece, the method comprising:
i) providing the assembly of claim 1;
ii) moving the mobile transport device to the installation device;
iii) determining position of the mobile transport device relative to the installation device with a sensor device;
iv) checking whether position of the mobile transport device relative to the installation device is in a predetermined handover position region;
v) establishing electrical connection between the mobile transport device and the installation device when the position of the mobile transport device is in the predetermined handover position region; and
vi) activating the transport device conveyor device so that a workpiece is conveyed from the mobile transport device to the installation device or from the installation device to the mobile transport device.

37. The method according to claim 40, further comprising:
operating a brake device to limit movability of the mobile transport device when the mobile transport device is electrically connected to the installation device; and/or
configuring a locking device to hold or secure the brake device in its braking position when the mobile transport device is electrically connected to the installation device; and/or
operating a light to emit light when the mobile transport device is electrically connected to the installation device.

38. A mobile transport device having a transport device conveyor device for use with a separate installation device having an installation device conveyor device, the mobile transport device comprising:
an electrical power supply connection configured to reversibly connect to an electrical power source of the installation device in order to supply electrical power from the installation device to the transport device conveyor device;
wherein the mobile transport device does not include an electrical power source comprising at least one of a current source and a battery.

39. A mobile transport device according to claim 38, wherein:
the electrical power supply connection comprises at least one two-pole contact receiving device configured to electrically connect to a two-pole contact producing device of the installation device.

40. A mobile transport device according to claim 39, wherein:
the transport device conveyor device is configured to operate in a first conveying direction when the two-pole contact producing device is connected to the two-pole contact receiving device and has a first polarity to permit the at least one workpiece to be conveyed in the first conveying direction; and
the transport device conveyor device is configured to operate in a second conveying direction opposite the first conveying direction when the two-pole contact producing device is connected to the two-pole contact receiving device and has a second polarity to permit the at least one workpiece to be conveyed in the second conveying direction.

41. An installation device having an installation device conveyor device for use with a separate mobile transport device having a transport device conveyor device, wherein the mobile transport device does not include an electrical power source comprising at least one of a current source and a battery, the installation device comprising:
an electrical power source; and
an electrical power supply connection configured to reversibly connect the electrical power source to the mobile transport device in order to supply electrical power from the installation device to the transport device conveyor device.

42. An installation device according to claim 41, wherein:
the electrical power supply connection comprises at least one two-pole contact producing device configured to electrically connect to a two-pole contact receiving device of the mobile transport device.
